(19) United States
(12) Patent Application Publication
(10) Pub. No.: US 2021/0119192 A1
(43) Pub. Date: Apr. 22, 2021

(54) CYLINDRICAL BATTERY PACK FOR ENERGY STORAGE SYSTEMS

(71) Applicant: ALAN GOTCHER & COMPANY INC., Incline Village, NV (US)

(72) Inventor: Alan J. Gotcher, Incline Village, NV (US)

(21) Appl. No.: 16/654,357

(22) Filed: Oct. 16, 2019

(51) Int. Cl. H01M 2/10; H01M 10/48; H01M 10/42; H01M 10/46; H01M 10/04

(52) U.S. Cl. CPC H01M 2/1077; H01M 10/482; H01M 10/425; H01M 2220/10; H01M 10/0422; H01M 10/486; H01M 2010/4271; H01M 10/465

(57) ABSTRACT

A cylindrical battery pack-based energy storage system is presented. The system includes a cylindrical battery pack configured for below grade installation and an environmental enclosure communicatively coupled with the cylindrical battery pack. The cylindrical battery pack includes battery modules, a cylindrical environmental enclosure configured to be filled with an inert gas, and a controller. The battery modules include lithium ion, advanced lithium ion, metal air, lead acid, advanced lead acid batteries, and/or rechargeable alkaline battery cells. The cylindrical environmental enclosure includes dual walls, end caps, and sensors for detecting moisture, pressure, and/or temperature. The environmental enclosure includes electronics configured to control the supply to and from the one or more battery modules.

### FIELD

The present disclosure relates to relates generally to battery structures and more particularly to a cylindrical battery pack for energy storage systems.

### SUMMARY

A cylindrical battery pack energy storage system is presented. The disclosed system includes a cylindrical battery pack configured for below-grade installation and an enclosure communicatively coupled with the one or more cylindrical battery packs. The cylindrical battery pack includes one or more battery modules, a cylindrical environmental enclosure, and a controller.

In an aspect of the present disclosure, the one or more battery modules may include lithium ion, advanced lithium ion, metal air, lead acid, advanced lead acid batteries, and/or rechargeable alkaline battery cells.

In another aspect of the present disclosure, the cylindrical battery pack enclosure may include dual walls.

In yet another aspect of the present disclosure, the cylindrical battery pack enclosure may include one or more end caps.

In a further aspect of the present disclosure, the cylindrical battery pack enclosure may include sensors configured to detect moisture, pressure, and/or temperature.

In yet a further aspect of the present disclosure, the cylindrical battery pack enclosure may be configured to be filled with an inert gas.

In an aspect of the present disclosure, the enclosure may include electronics configured to control supply to and from the one or more modules.

In another aspect of the present disclosure, the enclosure may be configured to be installed within a streetlight pole.

In yet another aspect of the present disclosure, the system may further include a photo voltaic array.

In a further aspect of the present disclosure, the system may further include a wireless communication cell, a wired communications and/or fiber communications.

In yet a further aspect of the present disclosure, the controller may execute a battery management system configured to measure battery cell temperatures, cell resistances, cell voltages, and cell currents.

In an aspect of the present disclosure, the system may be configured to store electrical energy from an electrical grid, a microgrid, and/or an electrical generation device.

In another aspect of the present disclosure, the one or more battery modules may include an elongated axis configured in a hexagonal, an octagonal, or other multi-sided non-rectangular shape.

A cylindrical battery pack configured for below grade installation is presented. The cylindrical battery pack includes one or more battery modules, a cylindrical battery pack enclosure, and a controller.

A cylindrical battery pack-based energy storage system is presented. The storage system includes one or more cylindrical battery packs configured for below grade installation and an enclosure communicatively coupled with the one or more cylindrical battery packs. The one or more cylindrical battery packs include: one or more battery modules, a cylindrical battery pack enclosure, and a controller. The storage system is configured to provide resilient power in the case of an electrical outage, and power at least one of streetlights, mobile communications power or power for sensors. The sensors include at least one of sound detection or weather measurements.

### BRIEF DESCRIPTION OF THE DRAWINGS

Various embodiments of the present disclosure are described herein below with references to the drawings, wherein:

FIG. 1 is a perspective view of an exemplary embodiment of a cylindrical battery pack in accordance with the present disclosure;

FIG. 2 is a top view of the cylindrical battery pack of FIG. 1;

FIG. 3 is a perspective view of the cylindrical battery pack of FIG. 1;

FIG. 4 is a bisected view of the cylindrical battery pack of FIG. 1;

FIG. 5 is a side view of the cylindrical battery pack and environmental enclosure of FIG. 1;

FIG. 6 is exemplary cylindrical battery pack characteristics and operating conditions in accordance with the present disclosure;

FIG. 7 is a front view of a cylindrical battery pack & energy storage system (ESS) in accordance with the present disclosure;

FIG. 8 is a front view of a two cylindrical battery pack-based ESS in accordance with the present disclosure;

FIG. 9 is a front view of a one cylindrical battery pack-based ESS combined with one modular power and energy ESS in accordance with the present disclosure;

FIG. 10 is a front view of a cylindrical battery pack-based ESS (CBP-ESS) combined with a streetlight pole to provide electrical resiliency for attached devices in accordance with the present disclosure;

FIG. 11 is a front view of a cylindrical battery pack-based ESS (CBP-ESS) combined with a previously installed or a nearby streetlight pole to provide resiliency for attached devices in accordance with the present disclosure;

FIG. 12 is a front view of cylindrical battery pack-based ESS (CBP-ESS) combined with a previously installed or a nearby streetlight pole to provide resiliency for attached devices, where one or more of the attached devices are 5G and/or 4G cellular communication devices in accordance with the present disclosure; and

FIG. 13 is a front view of a cylindrical battery pack-based ESS (CBP-ESS) combined with a previously installed or a nearby streetlight pole to provide resiliency for attached devices, where one or more of the attached devices are 5G and/or 4G cellular communication devices, and a PV array generation device is locally attached to provide microgrid power during daylight in accordance with the present disclosure.

### DETAILED DESCRIPTION OF THE DRAWINGS

In accordance with the present disclosure, a cylindrical battery pack for energy storage systems is presented, as illustrated in the attached figures. The system may be comprised of a number of different integral components. The system may include one or more cylindrical battery packs, a battery pack enclosure, an environmental enclosure, power cables, and data cables.

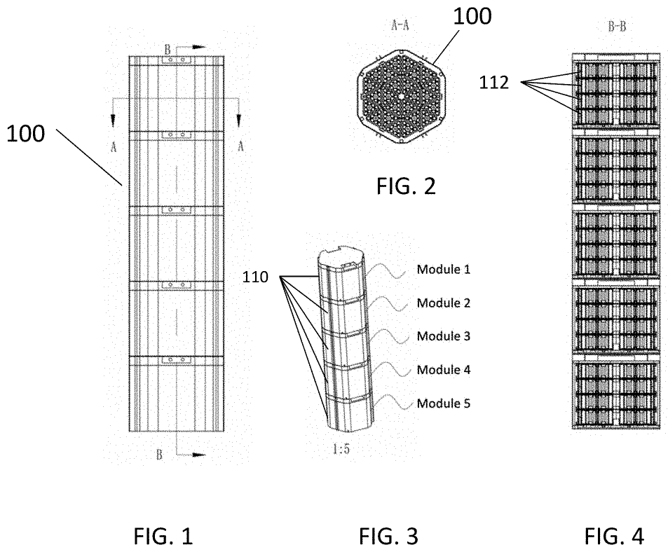

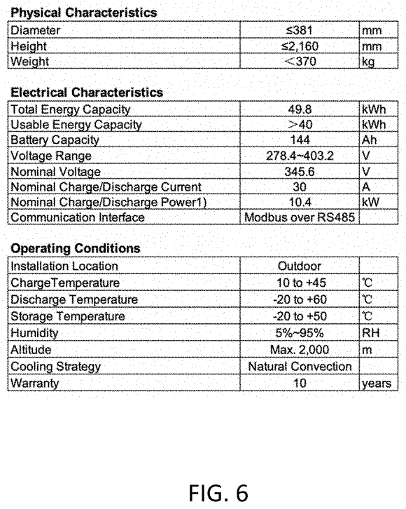

With reference to FIGS. 1-4 a cylindrical battery pack (CBP) 100 for energy storage is disclosed may be used in underground vaults nearby or underneath vehicle and people movement right of ways. The cylindrical battery pack 100 may be comprised of, for example, multiple battery cells 112 that are connected to each other in parallel and/or series and assembled into battery modules 110. One, or more, battery modules 110 are assembled into a cylindrical battery pack 100, which are monitored and controlled by a Battery Management System (BMS). The BMS can measure battery cell temperatures, cell resistances, cell voltage and currents, which are used to operate the battery pack within defined operating conditions. This cylindrical battery pack 100 can be used to store electrical energy from an electrical grid, microgrid or electrical generation device. In various embodiments, additional configurations of the battery module and resulting battery pack may be in hexagonal, octagonal or other multi-sided non-rectangular designs on an elongated axis. For example, the battery pack may be used for distributed energy storage connected to microgrids. Exemplary CBP characteristics and operating conditions are illustrated in the table of FIG. 6. The battery pack has increased safety based on its location underground.

In various embodiments, a range of rechargeable battery chemistries may be used for the battery cells selected to be used in the assembly of the cylindrical battery modules and battery pack. For example, lithium ion batteries may be used. In various embodiments, other cell formats and configurations may be used for the battery modules used within the cylindrical environmental enclosure installed underground (e.g., lithium-ion, advanced lithium-ion, metal-air, lead-acid, advanced lead-acid batteries, and/or rechargeable alkaline battery cells).

Lithium-ion chemistries can be represented by, for example: lithium cobalt oxide (LiCoO2 or LCO), lithium iron phosphate (LiFePO4 or LFP), lithium manganese oxide (LiMn2O4 or LMO), lithium nickel cobalt aluminum oxide (LiNiCoAlO2 or NCA), lithium nickel manganese cobalt oxide (LiNixMnyCol-x-yO2 or NMC), lithium polymer, lithium Titanate (Li4Ti5O12 or LTO) and lithium-sulfur (Li—S) chemistries. Advanced lithium-ion chemistries can be represented by, for example, Silicon modified anodes. nickel chemistries can be represented by, for example, nickel cadmium (NiCd), nickel Hydrogen (NiH2), nickel Iron (NiFe), nickel metal hydride (NiMH), and nickel zinc (NiZn). metal Air chemistries may be represented by, for example: lithium-air (Li air), sodium air (Na air), potassium air (K air), zinc air (Zn air), magnesium air (Mg air), calcium air (Ca air), aluminum air (Al air), Iron air (Fe air) and silicon air (Si air).

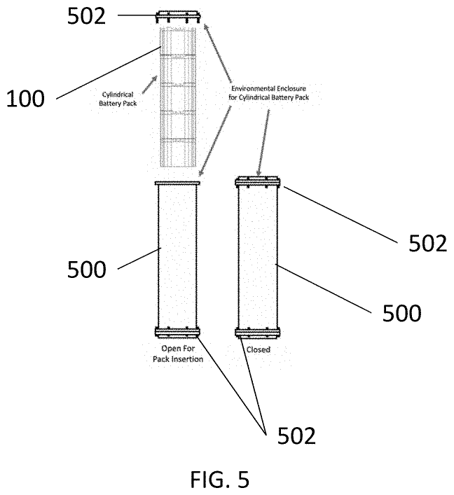

With reference to FIG. 5, shown is a cylindrical battery pack 100 inserted (housed) within an environmental enclosure 500 to protect the battery pack from environmental exposure is disclosed. In various embodiments, the environmental enclosure 500 is a cylindrical, end-capped 502 tubular shape designed for either below and above grade installation (underground or on ground). In various embodiments, when the cylindrical battery pack 100 is installed below grade, it may be installed within a battery vault usually made from concrete to physically protect the cylindrical battery pack 100 and environmental enclosure 500. A battery vault can be optional for an underground installation. In various embodiments, the environmental enclosure 500 may include a dual-wall design constructed from either metal, plastic or other materials capable of withstanding environmental exposure to fluids (e.g. fresh or saltwater, petroleum-based fluids, etc.), vibration and microbial attack, etc. In various embodiments, the enclosure may be designed for either passive or active thermal management. In various embodiments, the environmental enclosure 500 may include an inert gas over-pressure to reduce moisture ingress and to reduce the likelihood of lithium-ion cell thermal runaway and fire. In various embodiments, the environmental enclosure 500 may include multiple sensors mounted internally to measure and monitor selected variables such as gas pressure, moisture vapor, fluid level and the like. In various embodiments, the environmental enclosure 500 may include dual wall construction with multiple sensors for detection of moisture, the measurement of pressure and temperature such as ambient and battery pack temperatures. In various embodiments, sensors may be mounted on the interior of the environmental enclosure 500 and between the enclosure walls.

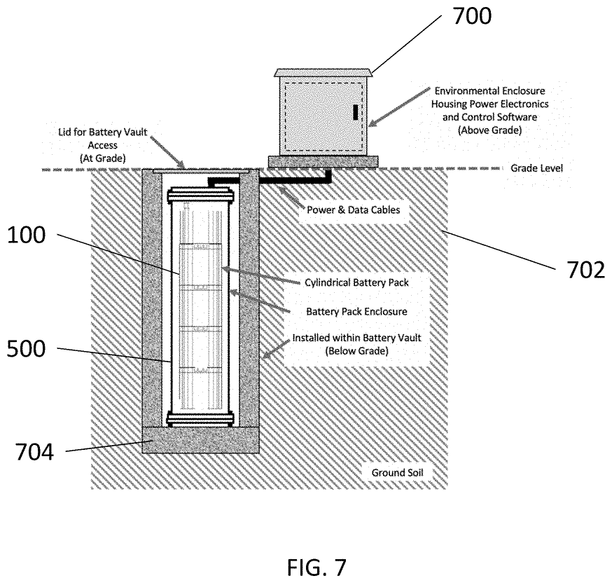

With reference to FIG. 7, a cylindrical battery pack-based energy storage system is disclosed. In various embodiments, the cylindrical battery pack 100 and BMS may be installed within a cylindrical environmental enclosure 500 which can be installed below grade in a concrete vault 704 (underground), or optionally, above grade. In various embodiments, when combined with appropriate power electronics and software controls, the cylindrical battery pack 100, BMS, power electronics and software controls can be used as an energy storage system (CBP-ESS). The power electronics and software controls can be co-located with the cylindrical battery pack 100, or the cylindrical battery pack 100 can be installed below grade, and the power electronics and software controls can be installed nearby in a separate environmental enclosure 700 installed above grade. In various embodiments, multiple cylindrical battery packs 100 can be installed in a combination of below-grade enclosures and above grade enclosures.

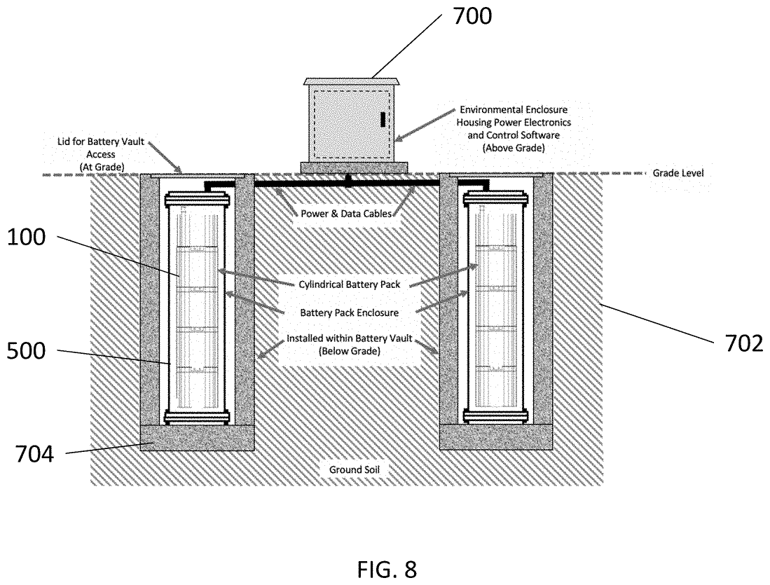

FIG. 8 shows a front view of a multiple cylindrical battery pack-based ESS (CBP-ESS) in accordance with the present disclosure. In various embodiments, one or more cylindrical battery 100 pack-based energy storage systems can be managed together, or separately, to provide distributed local energy services for retail energy customers and/or aggregated to provide energy services for the electrical grid, microgrids or utilities. The combined cylindrical ESS solutions provide a wide range of potential ESS configurations and allow customized energy services at each distributed energy storage site. In various embodiments, these distributed energy storage solutions may be used separately or in combination to provide aggregated energy services for multiple customer segments.

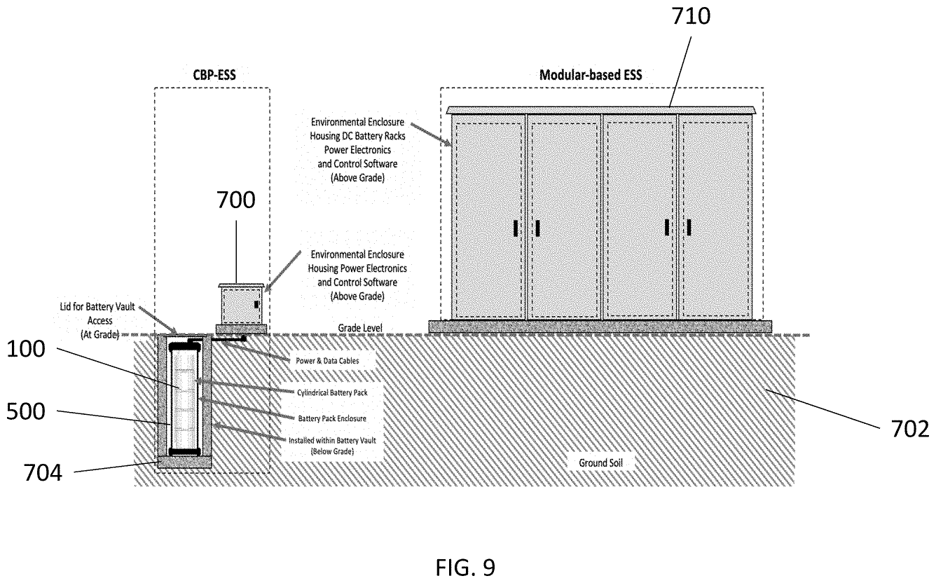

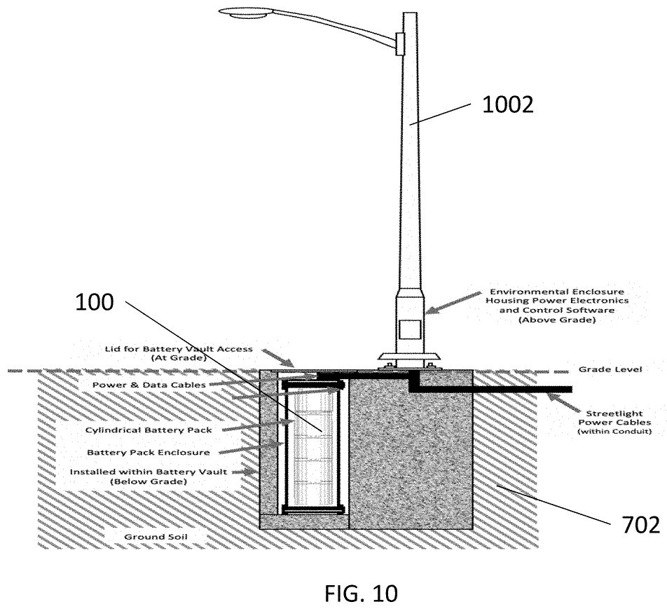

FIG. 9 shows a front view of a one cylindrical battery pack-based ESS combined with one modular power and energy ESS in accordance with the present disclosure. In various embodiments, one or more cylindrical battery pack-based energy storage systems can be managed together and configured with one or more modular energy or power energy storage systems are disclosed. For example, a modular based ESS 710 may be located above grade. The combined cylindrical battery pack 100, Environmental enclosure 700, and modular ESS 710 provide a wide range of potential ESS configurations and allow for customized energy services at each distributed energy storage site. These distributed, modular and/or centralized energy storage solutions may be used separately or in combination to provide aggregated energy services. In various embodiments, one or more cylindrical battery pack-based energy storage systems may be managed together and configured with one or more modular energy or power energy storage systems where the battery pack can monitor and control a micro-grid are disclosed.

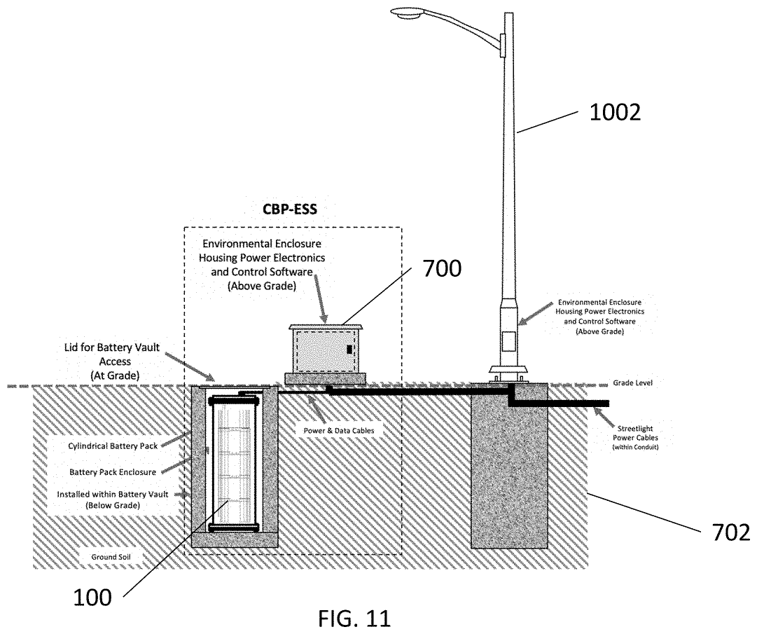

FIG. 10 shows a front view of a cylindrical battery pack-based ESS (CBP-ESS) combined with a streetlight pole 1002 in accordance with the present disclosure. In various embodiments, the power electronics and control software may be installed within the street light pole 1002. FIG. 11 shows a front view of a cylindrical battery pack-based ESS (CBP-ESS) combined with a previously installed or a nearby streetlight pole 1202 in accordance with the present disclosure.

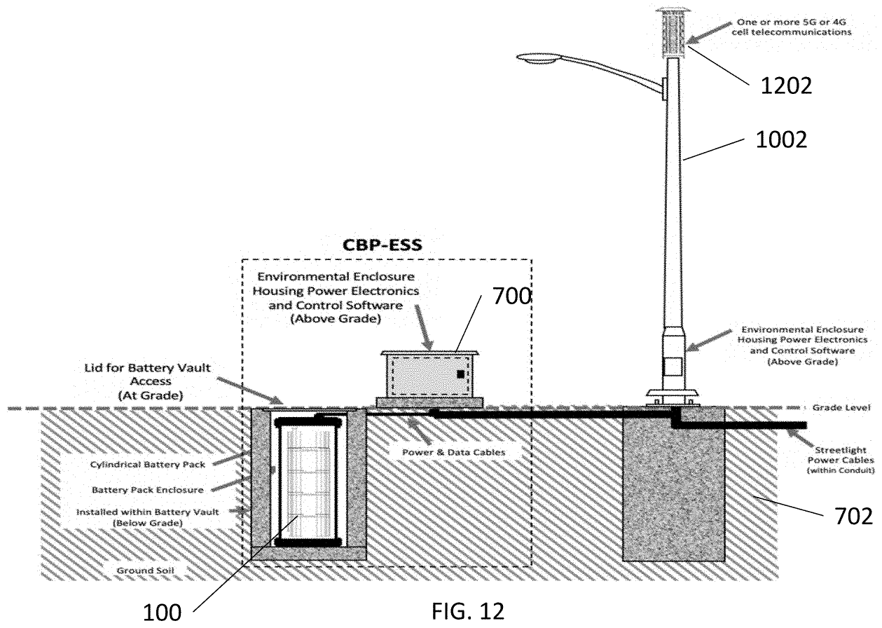

FIG. 12 shows a front view of cylindrical battery pack-based ESS (CBP-ESS) combined with a previously installed or a nearby streetlight pole 1002, including attached devices, in accordance with the disclosure. For example, one or more of the attached devices may include 5G and/or 4G cellular communication devices 1202. Alternatively, the 5G and/or 4G communication devices and be housed in the above ground environmental enclosure 700 or communications can be made by cable or fiber connections.

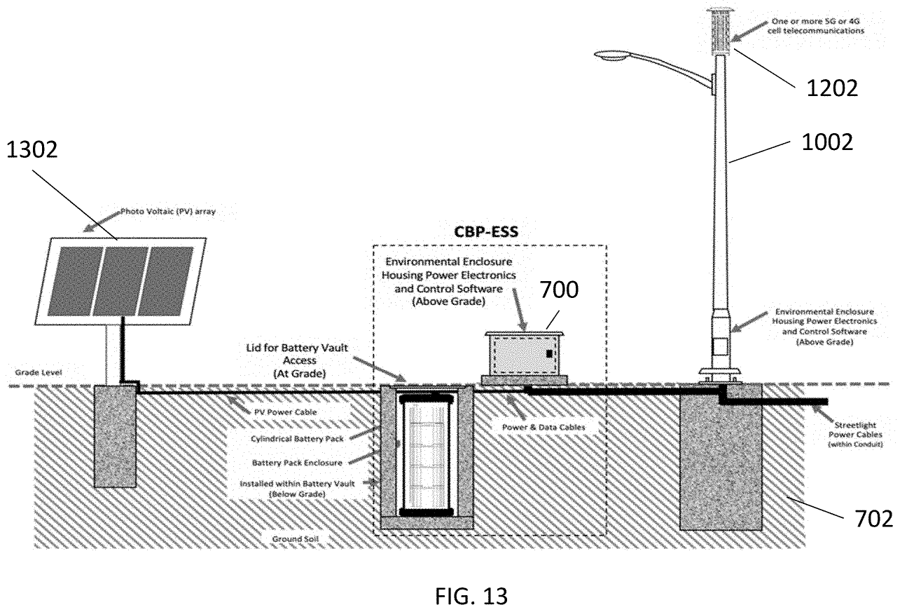

FIG. 13 shows a front view of a cylindrical battery pack-based ESS (CBP-ESS) combined with a previously installed or a nearby streetlight pole 1002 including attached devices in accordance with the disclosure. For example, one or more of the attached devices are 5G and/or 4G cellular communication devices 1202, and a PV array generation device 1302 is locally attached to provide microgrid power during. The PV device 1302 may be used to charge the CBP-ESS

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A cylindrical battery pack-based energy storage system comprising:
one or more cylindrical battery packs configured for below grade installation, the one or more cylindrical battery packs including:
one or more battery modules;
a cylindrical battery pack enclosure; and
a controller; and
an enclosure communicatively coupled with the one or more cylindrical battery packs.

2. The system of claim 1, wherein the one or more battery modules include at least one of lithium ion, advanced lithium ion, metal air, lead acid, advanced lead acid batteries, or rechargeable alkaline battery cells.

3. The system of claim 1, wherein the cylindrical battery pack enclosure includes dual walls.

4. The system of claim 1, wherein the cylindrical battery pack enclosure includes one or more end caps.

5. The system of claim 1, wherein the cylindrical battery pack enclosure includes sensors configured to detect at least one of moisture, pressure, or temperature.

6. The system of claim 1, wherein the cylindrical battery pack enclosure is configured to be filled with an inert gas.

7. The system of claim 1, wherein the enclosure including electronics is configured to control electrical supply to and from the one or more modules.

8. The system of claim 1, wherein the enclosure is configured to be installed within a streetlight pole.

9. The system of claim 1, wherein the system further includes a photo voltaic array.

10. The system of claim 1, wherein the system further includes at least one of a wireless communication cell, a wired communications, or fiber communications.

11. The system of claim 1, wherein the controller executes a battery management system configured to measure battery cell temperatures, cell resistances, cell voltages, and cell currents.

12. The system of claim 1, wherein the system is configured to store electrical energy from at least one of an electrical grid, a microgrid, or an electrical generation device.

13. The system of claim 1, wherein the one or more battery modules include an elongated axis configured in a hexagonal, an octagonal, or other multi-sided non-rectangular shape.

14. A cylindrical battery pack configured for below grade installation, the cylindrical battery pack comprising:
one or more battery modules;
a cylindrical battery pack enclosure; and
a controller.

15. The cylindrical battery pack of claim 14, wherein the one or more battery modules include at least one of lithium ion, advanced lithium ion, metal air, lead acid, advanced lead acid batteries, or rechargeable alkaline battery cells.

16. The cylindrical battery pack of claim 14, wherein the cylindrical battery pack enclosure includes dual walls.

17. The cylindrical battery pack of claim 14, wherein the cylindrical battery pack enclosure includes one or more end caps.

18. The cylindrical battery pack of claim 14, wherein the cylindrical battery pack enclosure includes sensors configured to detect at least one of moisture, pressure, or temperature.

19. The cylindrical battery pack of claim 14, wherein the cylindrical battery pack enclosure is configured to be filled with an inert gas.

20. A cylindrical battery pack-based energy storage system comprising:
one or more cylindrical battery packs configured for below grade installation, the one or more cylindrical battery packs including:
one or more battery modules;
a cylindrical battery pack enclosure; and
a controller; and
an enclosure communicatively coupled with the one or more cylindrical battery packs,
wherein the storage system is configured to provide resilient power in the case of an electrical outage, and power at least one of streetlights, mobile communications power or power for sensors, and
wherein the sensors include at least one of sound detection or weather measurements.
